(19) United States
(12) Patent Application Publication
(10) Pub. No.: US 2022/0326730 A1
(43) Pub. Date: Oct. 13, 2022

(54) HEAD-MOUNTED IMAGE DISPLAY APPARATUS

(71) Applicant: SONY GROUP CORPORATION, TOKYO (JP)

(72) Inventor: YUICHIRO ASHIDA, TOKYO (JP)

(21) Appl. No.: 17/764,624

(22) PCT Filed: Sep. 28, 2020
(86) PCT No.: PCT/JP2020/036587

§ 371 Date: Mar. 29, 2022

(30) Foreign Application Priority Data
Oct. 7, 2019 (JP) 2019-184796

(51) Int. Cl. G06F 1/16

(52) U.S. Cl. CPC G06F 1/163

(57) ABSTRACT

To provide an HMD that provides a wearing comfort and a high degree of detachability regardless of the size of the head of a user. A head-mounted image display apparatus according to an embodiment of the present technology includes a display-section body, a holding section, and a weight section. The display-section body displays an image in front of eyes of a user. The holding section is mounted on a head of the user, and includes a first arm that movably holds the display-section body. The weight section includes a weight, and a second arm that is provided to the holding section and movably holds the weight; and is balanced with the display-section body in the holding section.

### TECHNICAL FIELD

The present technology relates to a head-mounted image display apparatus used for, for example, gaming and simulation.

### BACKGROUND ART

A head-mounted image display apparatus (a head-mounted display, HMD) that is worn on the head of an observer (a user) is known. In recent years, an apparatus is known that causes a user to feel as if a virtual reality space created by displaying an image using a technology called virtual reality (VR) or mixed reality (MR), is a real space.

It is necessary that something that reduces a sense of immersion that causes a user to more strongly feel as if a virtual space is a real space be eliminated as much as possible when such an HMD for VR or MR is used. There is a need for such an HMD for VR or MR to be comfortable to wear without providing a feeling of pressure, to be stable upon being worn, and to be easily detachable (for example, refer to Patent Literature 1).

In Patent Literature 2, the arrangement of a weight canceller (a weight) is set such that the center of gravity of the entirety of an HMD coincides the center of the head, in order to reduce neck strain due to the position of the center of gravity of the HMD. Then, from among a force pulling up the weight canceller through a cable, a component of a force in a direction that is different from a direction of a gravitational pull is applied to the forehead of a user. This results in the entirety of the HMD being held by the top of the head and the forehead of the user.

In Patent Literature 3, a display section and a battery holder are arranged symmetrically about the top of the head through a body arm, in order to reduce the burden on a user due to the position of the center of gravity of an HMD, as in the case of Patent Literature 2. Then, a ball joint attached to an upwardly extending portion that extends from the body arm makes it possible to adjust the rotation of the battery holder.

### CITATION LIST

### Patent Literature

Patent Literature 1: Japanese Patent Application Laid-open No. 2014-068184
Patent Literature 2: Japanese Patent Application Laid-open No. 2017-229048
Patent Literature 3: Japanese Patent Application Laid-open No. 2018-157476

### DISCLOSURE OF INVENTION

### Technical Problem

However, in the case of Patent Literature 2, the component of a force of the weight canceller being applied to the forehead is changed according to the size of the head, and this may result in reducing the wearability, such as reducing the stability when the HMD is worn and causing an excessive feeling of pressure.

In the case of Patent Literature 3, a range used to adjust a position of the battery holder is restricted by a distance between the ball joint and the battery holder, which makes it difficult to ensure the positional adjustment range. This may result in difficulty in achieving an optimal balance depending on the size of the head of a user. Further, Patent Literature 3 also discloses making the positional adjustment range broader using a mechanism in which the upwardly extending portion is rotated. However, the structure is complicated, and a battery is arranged away from the head of a user. This may result in increasing the risk of colliding with something in the surroundings due to the user in a state of wearing an HMD moving in a virtual space.

In view of the circumstances described above, it is an object of the present technology to provide an HMD that provides a wearing comfort and a high degree of detachability regardless of the size of the head of a user.

### Solution to Problem

In order to achieve the object described above, a head-mounted image display apparatus according to an embodiment of the present technology includes a display-section body, a holding section, and a weight section.

The display-section body displays an image in front of eyes of a user.

The holding section is mounted on a head of the user, and includes a first arm that movably holds the display-section body.

The weight section includes a weight, and a second arm that is provided to the holding section and movably holds the weight; and is balanced with the display-section body in the holding section.

This enables the user to arrange the body and the weight at desired positions, and thus to obtain a wearing comfort and a high degree of detachability regardless of the size of the head of the user.

The holding section may include a holding-section body that includes a first groove and a second groove that are respectively used to accommodate the first arm and the second arm, and the first arm and the second arm may be respectively movable within and along the first groove and the second groove.

This makes it possible to set the display-section body and the weight at desired positions according to the size of the head.

The first arm and the second arm may form an arc shape, and the first groove and the second groove may form an arc shape.

The arc shape along a shape of the head of a user makes it possible to obtain the holding section having a small footprint.

The display-section body may include a barrel that holds an optical element and a display element, and the barrel may be movable in the display-section body in a direction of a line of sight of the user.

This makes it possible to move the display element to an appropriate position according to the size of the head of a user and according to the interpupillary distance of the user.

The holding section may further include a first joint that enables the display-section body to be rotated about a single axis with respect to the first arm.

This makes it possible to adjust an inclination of the display-section body such that the optical axis of the display-section body coincides the visual axis of a user.

The first arm may be movable such that the display-section body is moved up to a first back-away position at which the display-section body is in contact with, or is situated near the holding-section body.

This makes it possible to reduce a storage space.

The holding section may further include sandwiching arms between which the head of the user is sandwiched from two sides of the head.

This results in being more stable upon being worn.

The holding section may further include a side-of-head contact portion that is provided to a tip of the sandwiching arm and covers a corresponding one of two ears of the user.

The second arm may be movable such that the weight is moved up to a second back-away position at which the weight is in contact with, or is situated near the holding-section body.

Each of the first groove and the second groove may include an uneven portion on two side faces of the corresponding groove, and each of the first arm and the second arm may include a tip that includes an elastically deformable protrusion that is engaged with the corresponding uneven portion.

The first arm may include a sliding portion that is slidable along the first groove, with specified friction being caused between the sliding portion of the first arm and the first groove, and the second arm may include a sliding portion that is slidable along the second groove, with specified friction being caused between the sliding portion of the second arm and the second groove.

The holding section may further include a weight drive section that moves the weight from the second back-away position to a specified position.

This makes it possible to automatically adjust the position of the weight.

The weight drive section may include an actuator that moves the weight from the second back-away position to the specified position, and a biasing member that biases the weight toward the second back-away position from the specified position.

The holding section may further include a second joint that enables the weight section to be rotated about a single axis.

### BRIEF DESCRIPTION OF DRAWINGS

FIG. 1 schematically illustrates an HMD according to a first embodiment of the present technology.

FIG. 2 is a front view schematically illustrating the HMD of FIG. 1 in a state of not being worn by a user and in a state of being worn by the user.

FIG. 3 (a) of FIG. 3 is a cross-sectional view of an HMD holding section of (b) of FIG. 1 in an x-axis direction, and (b) of FIG. 3 is a partially enlarged perspective view, as viewed from a direction indicated by an arrow A of (a) of FIG. 3.

FIG. 4 is an enlarged plan view illustrating a shape of a tip of each of an HMD-body arm and a weight arm.

FIG. 5 (a) of FIG. 5 is a cross-sectional view of the body arm and the weight arm in an x-axis direction, where the body arm and the weight arm are respectively inserted into a first groove and a second groove of the HMD holding section, and (b) of FIG. 5 is a partially enlarged perspective view (b), as viewed from a direction indicated by an arrow A of (a) of FIG. 5.

FIG. 6 is a set of a front view (a) and a side view (b) each schematically illustrating a user having a relatively large head is wearing the HMD.

FIG. 7 is a set of a front view (a) and a side view (b) each schematically illustrating a user having a relatively small head is wearing the HMD.

FIG. 8 is a set of a front view (a) and a side view (b) each schematically illustrating the HMD not being worn by a user.

FIG. 9 is an enlarged plan view illustrating shapes of tips of an HMD-body arm and a weight arm according to a modification of the present technology.

FIG. 10 schematically illustrates an HMD according to a second embodiment of the present technology.

FIG. 11 is a cross-sectional view along the line A-A of (a) of FIG. 10.

FIG. 12 is a control block diagram of the HMD according to the present technology.

FIG. 13 is a flowchart illustrating a weight position adjusting method according to the present technology.

FIG. 14 schematically illustrates an HMD according to a third embodiment of the present technology.

### MODE(S) FOR CARRYING OUT THE INVENTION

Embodiments according to the present technology will now be described below with reference to the drawings. Note that similar reference numerals represent structural elements that include similar functions.

### First Embodiment

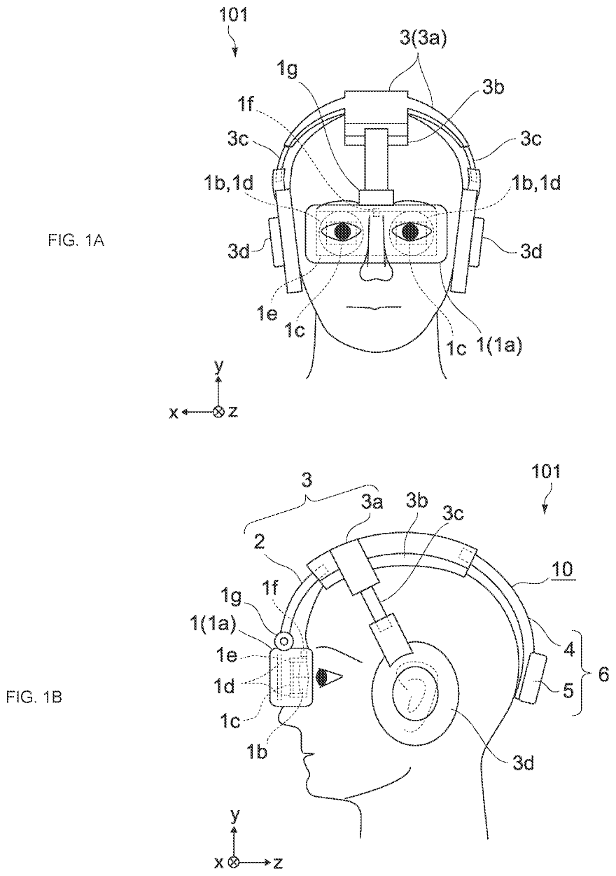

FIG. 1 is a general schematic diagram illustrating a state in which a user is wearing a head-mounted image display apparatus 101 (hereinafter referred to as a head-mounted display, HMD) according to a first embodiment of the present technology.

(a) of FIG. 1 is a front view of the user, as viewed from the front, and (b) of FIG. 1 is a side view of the user, as viewed from a left side.

The HMD 101 includes an image-display-apparatus body 1 (hereinafter also referred to as an HMD body) that is a display-section body, an image-display-section holding section 3 (hereinafter also referred to as an HMD holding section) that is a holding section, and a weight section 6.

Note that an x-axis direction and a z-axis direction in the figure represent a horizontal direction in an xyz coordinate system to which the HMD 101 belongs. It is assumed that the x-axis direction is a “first axial direction”, and is a left-and-right direction of the HMD 101. It is assumed that a y-axis direction is a “second axial direction”, and is an up-and-down direction of the HMD 101 that is orthogonal to the x-axis direction.

It is assumed that the z-axis direction indicates a direction that is orthogonal to the x-axis direction and the y-axis direction, and is a front-rear direction of the HMD 101. Likewise, it is assumed that, when the HMD 101 is worn by the user, the x-axis direction is a left-and-right direction of the user, the y-axis direction is an up-and-down direction of the user, and the z-axis direction is a front-rear direction of the user.

The HMD 101 is, for example, a non-transmissive HMD in the form of goggles, and is configured such that display elements 1c described later are respectively arranged in front of the eyes of the user by the HMD 101 being worn on the head of the user.

[HMD Body]

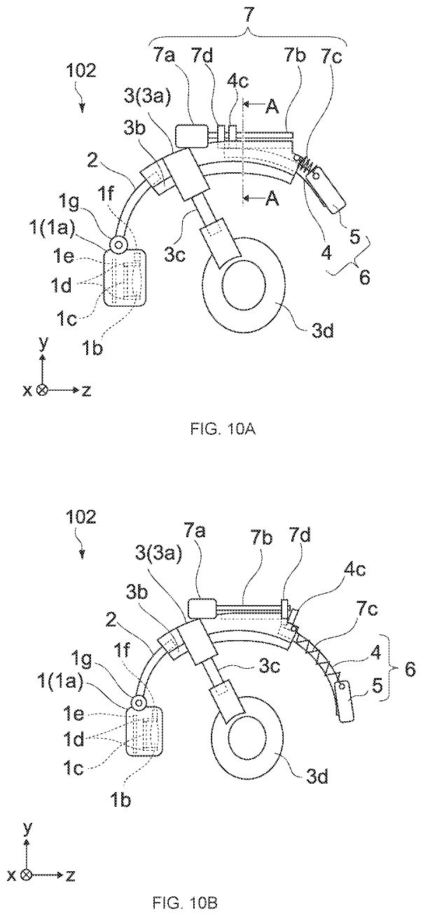

The HMD body 1 displays an image in front of the eyes of a user, and includes an HMD housing 1a, an ocular optical element (hereinafter referred to as an ocular lens) 1b, the display element (hereinafter referred to as a panel) 1c, a barrel 1d, a drive substrate 1e, and an ocular contact detector 1f. The ocular lens 1b, the panel 1c, the barrel 1d, the drive substrate 1e, and the ocular contact detector 1f are held in the HMD housing 1a (refer to FIGS. 1 and 10).

Here, the image may be a still image or a moving image. The image may be text information. The image is typically a VR image or an MR image, but of course the image is not limited thereto.

The HMD housing 1a is configured such that the entirety of the HMD housing 1a covers the eyes of a user to be situated close to the face of the user or to fit the face of the user. The HMD housing 1a is configured such that the entirety of the HMD housing 1a is formed into a half-disk shape bulging in the z-axis direction and covers the front of the eyes of the user.

Two ocular lenses 1b and two panels 1c are held in the HMD housing 1a, and the ocular lens 1b and the panel 1c are arranged to be situated in front of each of the left and right eyes of the user.

For example, the ocular lens 1b is made of resin, and is a lens that magnifies an image displayed on the panel 1c to cause a user to visually recognize the image. In FIG. 1, the ocular lens 1b is formed of a single lens for convenience, but the ocular lens 1b may be formed of a plurality of lenses. The barrel 1d is used to hold the ocular lens 1b and the panel 1c. The barrel 1d holds the ocular lens 1b and the panel 1c such that a center of the ocular lens 1b that corresponds to an optical axis of the ocular lens 1b and a center of the panel 1c (in x and y directions in the figure) are situated at a specified position, and such that a space between an optical-axis direction of the ocular lens 1b and an optical-axis direction of the panel 1c (in a z direction in the figure) is situated at a specified position.

The barrel 1d includes a holding portion (not illustrated), and the barrel 1d is held in the HMD housing 1a by use of the holding portion. Further, the barrel 1d is held in the HMD housing 1a to be movable in a direction in parallel with a line that connects pupils (a direction of a line of sight of a user, and in the x-axis direction in the figure), and in an eyerelief direction (the z direction in the figure). This makes it possible to move the barrel 1d to an appropriate position according to the size of the head of a user who is wearing the HMD 101 and according to the interpupillary distance of the user.

Note that the ocular lens 1b, the panel 1c, and the barrel 1d for the right eye respectively have configurations that are similar to configurations of the ocular lens 1b, the panel 1c, and the barrel 1d for the left eye. Thus, the ocular lens 1b, the panel 1c, and the barrel 1d for the right eye are respectively denoted by reference numerals similar to reference numerals of the ocular lens 1b, the panel 1c, and the barrel 1d for the left eye.

The panel 1c is a display element that includes a liquid crystal or an organic EL, and enables display information to emit light, the display information being information to be visually recognized by a user. For example, the panel 1c is electrically connected to the drive substrate 1e using a flexible printed circuit (FPC, not illustrated).

The drive substrate 1e includes a power supply section of the HMD body 1, an image processor used to perform settings for displaying an image on the panel 1c, and a drive section of the ocular contact detector 1f.

The drive substrate 1e is electrically connected to an external PC (for example, refer to FIG. 12) for control and for an image signal, using a USB cable or an HDMI (registered trademark) cable. In the present embodiment, the drive substrate 1e is configured as a controller that controls the HMD 101 on the basis of a power supply and an image signal from the external PC.

The ocular contact detector 1f is an attachment detecting mechanism that detects whether the HMD 101 is worn by a user. The ocular contact detector 1f internally includes a light emitter that emits infrared light, and a light-receiving section that receives reflected light in a wavelength band of the infrared light.

When the HMD 101 is worn by the user, an attachment state is detected by light reflected off the skin of the user being constantly received. When the HMD 101 is not worn by the user, the state is determined to be a non-attachment state by infrared light not entering the light-receiving section.

The HMD body 1 further includes, at its upper end, a first joint 1g that is a rotation portion of the HMD body. The first joint 1g may be formed integrally with the HMD housing 1a .

The first joint 1g is rotatably engaged with an HDM-body arm 2 described later. With respect to the HMD-body arm 2, the HMD body 1 can be rotated about an axis (the X axis) extending in parallel with the left-and-right direction of the user through the first joint 1g.

In the present technology, the HMD body 1 can be moved along an arc with respect to the holding section 3, which will be described in detail later. When the optical axis of the ocular lens 1b deviates from a visual axis of the user due to the movement, the user himself/herself rotates the first joint 1g, and this makes it possible to appropriately adjust an inclination of the HMD body 1 such that the optical axis of the ocular lens 1b coincides the visual axis of the user.

[HMD Holding Section]

As illustrated in FIG. 1, the HMD holding section 3 is a holding member that is worn on the head of the user, and is used to hold the HMD body 1 and a weight 5 described later at arbitrary positions such that the HMD 101 is worn on the head. The HMD holding section 3 includes the HDM-body arm (a first arm) 2 movably holding the HMD body 1.

On the other hand, the weight section 6 is balanced with the HMD body 1 in the HMD holding section 3. The weight section 6 includes the weight 5, and a weight arm (a second arm) 4 that movably holds the weight 5.

The HMD-body arm 2 and the weight arm 4 are held by a holding-section body 3a of the HMD holding section 3.

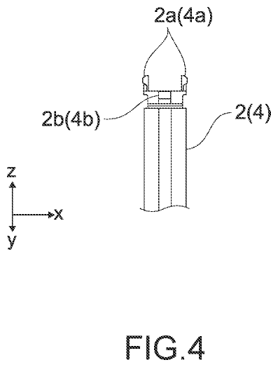

The HMD-body arm 2 connects the HMD body 1 and the HMD holding section 3. The HMD-body arm 2 is an arc-shaped member made of, for example, a resin material such as a polypropylene resin (PP) that is light in weight and has a relatively high elastic modulus, or a metallic material. A protrusion 2a that has spring properties is provided to a tip of the HMD-body arm 2 that is situated on the side of the holding-section body 3a (refer to FIG. 4). The HMD body 1 is fixed at an arbitrary position with respect to the holding-section body 3a due to a force of biasing performed by the protrusion 2a being applied to the holding-section body 3a. This will be described later.

The HMD-body arm 2 and the weight arm 4 are each engaged with the inside of the holding-section body 3a, and this results in the HMD body 1 and the weight 5 being held by the HMD holding section 3.

A top-of-head contact portion 3b that operates when the top of the head is subjected to weights of the HMD body 1, the HMD holding section 3, and the weight 5 is integrally formed on a bottom surface of the holding-section body 3a. The top-of-head contact portion 3b is formed using a member that is deformable along a shape of the head of the user. For example, the top-of-head contact portion 3b internally includes a hollow, and is formed by a rubber material or a sponge material that is made of, for example, urethane rubber being embedded in the hollow.

The HMD holding section 3 further includes a pair of sandwiching arms 3c between which the head of the user is sandwiched from the two sides of the head. The pair of sandwiching arms 3c is an arc-shaped member in which one of ends of each sandwiching arm 3c of the pair is integrally fixed to the holding-section body 3a, and the other ends of the respective sandwiching arms 3c of the pair respectively extend from the holding-section body 3a toward the right side and the left side of the head of the user. As in the case of the HMD-body arm 2, the pair of sandwiching arms 3c is made of, for example, a resin material such as a polypropylene resin (PP) that is light in weight and has a relatively high elastic modulus, or a metallic material. A side-of-head contact portion 3d is provided to a tip of each sandwiching arm 3c of the pair. The side-of-head contact portion 3d includes a member that can cover a corresponding one of two ears of the user. This results in the HMD 101 being more stable upon being worn on the head of the user.

FIG. 2 is a schematic front view schematically illustrating the HMD 101 in a state of not being worn by a user and in a state of being worn by the user.

When the HMD 101 is not worn by a user, the paired side-of-head contact portions 3d are situated close to each other in parallel with the x-axis direction (the left-and-right direction) in the figure, and, for example, the paired side-of-head contact portions 3d are at positions at which the paired side-of-head contact portions 3d overlap the HMD body 1 in parallel with the z-axis direction (the front-rear direction) (refer to (a) of FIG. 2). On the other hand, when the HMD 101 is worn by the user, the pair of sandwiching arms 3c is opened (elastically deformed) in parallel with a direction in which the paired side-of-head contact portions 3d are situated away from each other, as illustrated in (b) of FIG. 2. Consequently, the side-of-head contact portions 3d are moved to respective positions so that two ears of the user are covered with them. When there is no side-of-head contact portion 3d, the sandwiching arm 3c is brought into contact with the side of the head of the user.

A reaction force generated by the sandwiching arm 3c being elastically deformed corresponds to a biasing force with which the head is sandwiched between the side-of-head contact portions 3d from the respective sides of the head. Considering, for example, variations in the size of the head of a user, and weights of the HMD body 1 and the weight 5, the biasing force generated when the state is changed from a state in which the HMD 101 is not worn by a user to a state in which the HMD 101 is worn by the user is set such that the HMD 101 is not shifted from the front of the left and right eyes when the user turns his/her head around while playing, and such that an excessive feeling of pressure is not caused.

The side-of-head contact portion 3d is a member used to apply a sandwiching force generated by the sandwiching arms 3c to the sides of the head of a user. As in the case of the HMD holding section 3, a portion brought in contact with the side of the head of the user is formed using, for example, a sponge that enables the portion to be deformed along a shape of the side of the head of the user.

The side-of-head contact portion 3d may internally include an acoustic apparatus such as a headphone used to listen to sound associated with a moving image displayed on, for example, the panel 1c.

As described above, a sandwiching force is set using the sandwiching arm 3c regardless of weights and positions of the HMD body 1 and the weight 5. The side-of-head contact portion 3d is held at the tip of the sandwiching arm 3c to be relatively movable with respect to the holding-section body 3a. This makes it possible to adjust a position of the side-of-head contact portion 3d discretionarily according to the size of the head of the user.

[Weight Section]

The weight arm 4 includes the HMD holding section 3 and the weight 5. As in the case of the HMD-body arm 2, the weight arm 4 is an arc-shaped member made of, for example, a resin material such as polypropylene (PP) that is light in weight and has a relatively high elastic modulus, or a metallic material. A protrusion 4a that has spring properties is provided to a tip of the weight arm 4 that is situated on the side of the holding-section body 3a (refer to FIG. 4). The weight section 6 is fixed at an arbitrary position with respect to the holding-section body 3a due to a force of biasing performed by the protrusion 4a being applied to the holding-section body 3a. This will be described later.

The weight 5 is used to cancel a force that causes the HMD 101 to tilt toward the front of the head due to a weight of the HMD body 1. This will be described in detail later. In other words, the weight section 6 is balanced with the HMD body 1 in the HMD holding section 3. The weight 5 may be appropriately designed to be moved/fixed with respect to the weight arm 4.

The weight 5 is typically made of a metallic material that has a relatively great specific gravity such as brass. The weight of the weight 5 is set on the basis of a relationship between the centers of gravity of the HMD body 1, the weight 5, and the entirety of the HMD 101. When a material of the weight 5 has a greater specific gravity, this makes it possible to make the weight 5 smaller in size. The form of the weight 5 is not particularly limited, and an object in the form of masses that has an appropriate shape such as a shape of a rectangular parallelepiped or a spherical shape can be adopted. The weight 5 is not limited to an object in the form of masses, and may be, for example, a component or an apparatus such as a battery that has a weight greater than or equal to a specified weight.

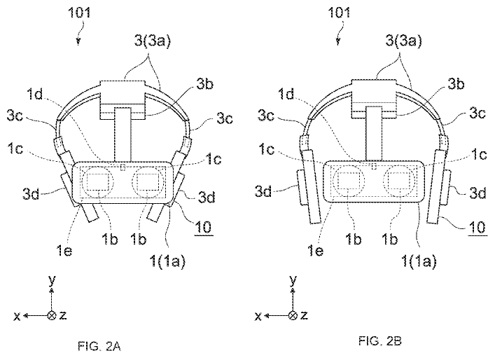

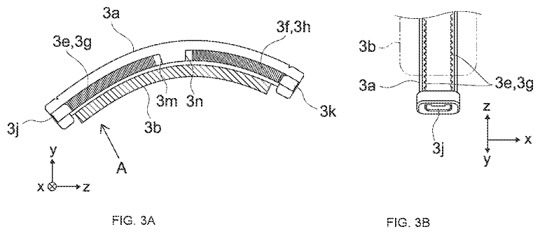

Here, a relationship between the HMD-body arm 2, the HMD holding section 3, and the weight arm 4 are described in detail with reference to FIGS. 3 to 5.

(a) of FIG. 3 is a cross-sectional view of the HMD holding section 3 of (b) of FIG. 1 in the x-axis direction, and (b) of FIG. 3 is a partially enlarged perspective view, as viewed from a direction indicated by an arrow A of (a) of FIG. 3.

The HMD holding section 3 includes a first groove 3g and a second groove 3h that are respectively used to accommodate the HMD-body arm 2 and the weight arm 4, and the HMD-body arm 2 and the weight arm 4 can be respectively moved within and along the first groove 3g and within and along the second groove 3h.

The HMD-body arm 2 and the weight arm 4 form an arc shape, and the first groove 3g and the second groove 3h form an arc shape. The arc shape includes shapes of an arc and an elliptical arc, and is along a shape of the head of a user in consideration of space-saving effects.

The first groove 3g includes an uneven portion 3e on its two side faces that face each other in the x-axis direction, and the second groove 3h includes an uneven portion 3f on its two side faces that face each other in the x-axis direction. The uneven portions 3e and 3f each have a wave shape, where the uneven portion 3e is formed from an end 3j on a side of an opening of the first groove 3g to an end 3m on a side opposite to the end 3j, and the uneven portion 3f is formed from an end 3k on a side of an opening of the second groove 3h to an end 3n on a side opposite to the end 3k.

As illustrated in (b) of FIG. 3, the wave shape of the uneven portion 3e is formed by a plurality of notch arcs provided on the two side faces of the first groove 3g, and the wave shape of the uneven portion 3f is formed by a plurality of notch arcs provided on the two side faces of the second groove 3h. The shape or the size of each notch arc (a width, a depth, and the like of unevenness) corresponds to the shape or the size of each of the protrusions 2a and 4a respectively provided to the tip of the HMD-body arm 2 and the tip of the weight arm 4, and is designed to enable each of the protrusions 2a and 4a to generate a desired biasing force (holding force).

FIG. 4 is an enlarged plan view illustrating a shape of the tip of each of the HMD-body arm 2 and the weight arm 4.

The protrusion 2a is provided to a tip 2b of the HMD-body arm 2. The protrusion 2a is formed into an arc shape to be capable of being engaged with the uneven portion 3e of the first groove 3g, and biases the uneven portion 3e in the x-axis direction with a specified elastic force. When a user performs an operation of pressing and pulling the HMD-body arm 2 with respect to the holding-section body 3a, this results in moving the protrusion 2a along the first groove 3g across the uneven portion 3e.

Likewise, the protrusion 4a is provided to a tip 4b of the weight arm 4. The protrusion 4a is formed into an arc shape to be capable of being engaged with the uneven portion 3f of the second groove 3h, and biases the uneven portion 3f in the x-axis direction with a specified elastic force. When a user performs an operation of pressing and pulling the weight arm 4 with respect to the holding-section body 3a, this results in moving the protrusion 4a along the second groove 3h across the uneven portion 3f.

The protrusions 2a and 4a are respectively integrally formed at the tip 2b of the HMD-body arm 2 and the tip 4b of the weight arm 4. However, the protrusions 2a and 4a may be formed using members that are different from the tips 2b and 4b. In this case, the protrusions 2a and 4a may be made of a material that is different from a material of the tips 2b and 4b. A joining method is not particularly limited, and bonding, welding, double mold, and other methods can be adopted.

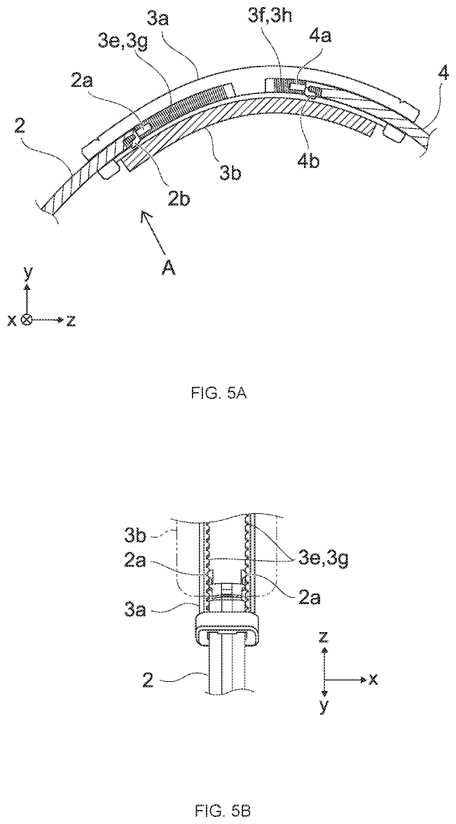

(a) of FIG. 5 is a cross-sectional view of the HMD-body arm 2 and the weight arm 4 in the x-axis direction in which the HMD-body arm 2 and the weight arm 4 are respectively inserted into the first groove 3g and the second groove 3h of the HMD holding section 3, and (b) of FIG. 5 is a partially enlarged perspective view (b), as viewed from a direction indicated by an arrow A of (a) of FIG. 5.

When the HMD-body arm 2 and the weight arm 4 are assembled into the HMD holding section 3, the protrusions 2a and 4a of the arms 2 and 4 are elastically deformed in the x-axis direction to be inserted into arbitrary positions in the grooves 3g and 3h. After the insertion, the protrusions 2a and 4a are respectively caught in the uneven portion 3e of the first groove 3g and the uneven portion 3f of the second groove 3h to serve as slip prevention portions that respectively prevent the HMD-body arm 2 and the weight arm 4 from being slipped out of the grooves 3g and 3h.

Note that a biasing mechanism that is similar to the mechanism described above can be adopted with respect to a positional adjustment between the tip of the sandwiching arm 3c and the side-of-head contact portion 3d, although this is not illustrated.

As described above, the protrusions 2a and 4a respectively bias to be engaged with the uneven portions 3e and 3f, and this results in the HMD-body arm 2 (the HMD body 1) and the weight arm 4 (the weight 5) are fixed to or held by the holding-section body 3a at arbitrary positions. Typically, the spring protrusions 2a and 4a are formed to form an arc shape that corresponds to a circle of which a radius is equal to a radius of a circle that corresponds to an arc shape formed by the uneven portions 3e and 3f, and the adjustment of the radiuses of the circles corresponding to those arc shapes makes it possible to set a smallest amount of a movement of each of the arms 2 and 4 discretionarily.

Note that a curvature of a circle corresponding to an arc drawn by the HMD-body arm 2 and the weight arm 4 in yz planes of (b) of FIG. 1 and (a) of FIG. 3, and a curvature of a circle corresponding to an arc drawn by the first groove 3g and the second groove 3h in the yz planes of (b) of FIG. 1 and (a) of FIG. 3, may be equal to each other or different from each other. In particular, an arc shape of the weight arm 4 is designed to be along the back of the head of a user, and this results in preventing the weight 5 from colliding with something in the surroundings without the weight 5 being situated too far away from the back of the head of a user regardless of the position of the weight arm 4 (the same applies to an arc shape of the HMD-body arm 2).

Next, a positional relationship between the HMD body 1, the weight 5, and the side-of-head contact portion 3d that is caused due to variations in the size of the head of the user is described in detail.

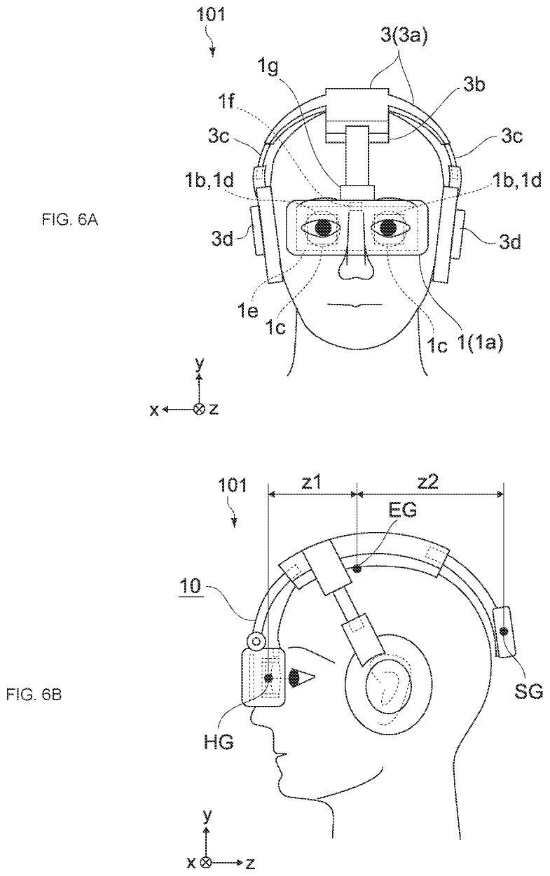

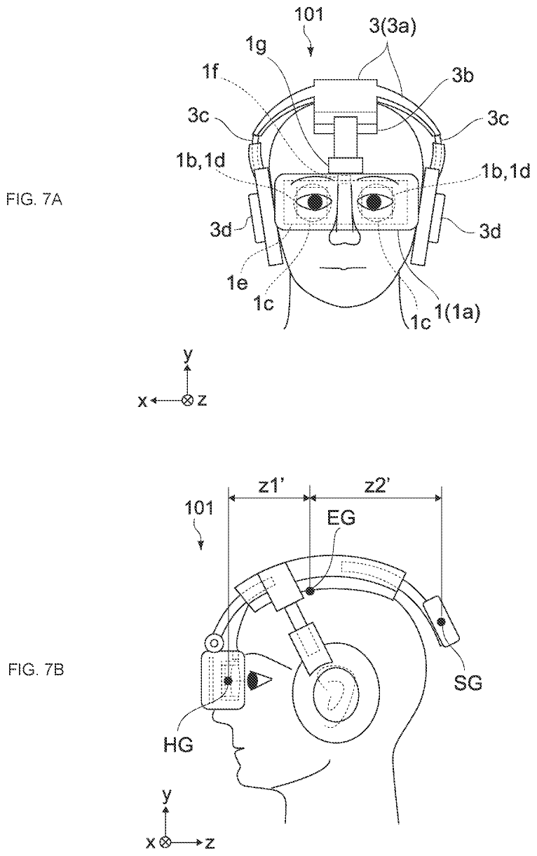

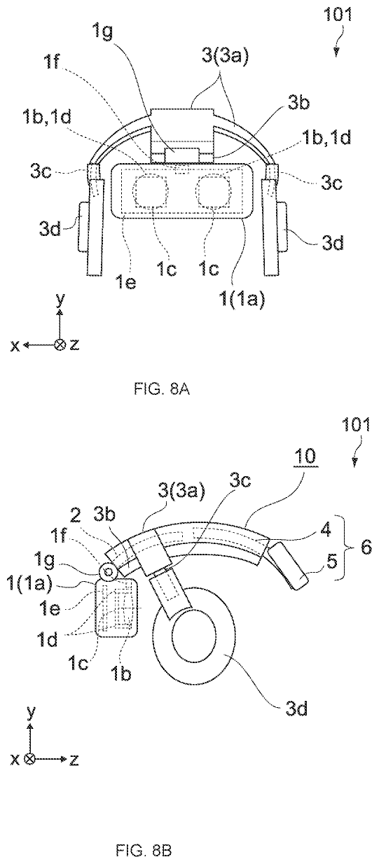

FIG. 6 is a set of a front view (a) and a side view (b) each schematically illustrating a user having a relatively large head is wearing the HMD 101.

FIG. 7 is a set of a front view (a) and a side view (b) each schematically illustrating a user having a relatively small head is wearing the HMD 101.

FIGS. 6 and 7 each illustrate a state in which the HMD body 1, the side-of-head contact portion 3d, and the weight 5 are arranged at positions that enable an optimal balance for each user to be achieved.

In (b) of FIG. 6 and (b) of FIG. 7, HG represents a center of gravity of the HMD body 1, SG represents a center of gravity of the weight 5, and EG represents a center of gravity of the entirety of the HMD 101.

In the figure, z1 is a distance in the z-axis direction from the center of gravity HG to the center of gravity EG, and z2 is a distance in the z-axis direction from the center of gravity EG to the center of gravity SG. When a weight of the HMD body 1 is represented by Wh, and a weight of the weight 5 is represented by Ws, relationships indicated below are satisfied considering a balance of forces due to the weights of the HMD body 1 and the weight 5.

Wh×z2/z1=Ws Formula (1)

Wh×z2′/z1′=Ws Formula (2)

In consideration of Formula (1) and Formula (2), the weight Ws of the weight 5, which is easily balanced with the weight Wh of the HMD body 1, is selected. Further, when the weight Ws of the weight 5 is desired to be made lighter, the position of the weight 5 is adjusted such that the distance z2 is made long due to the weight arm 4 being moved with respect to the holding-section body 3a, and this enables the center of gravity EG of the entirety the HMD 101 to be arranged near the neck of the user.

In the case of the user having a relatively small head, the distance z1′ in the z direction from the center of gravity HG to the center of gravity EG is assumed to be shorter than z1 in (a) of FIG. 6.

The position of the side-of-head contact portion 3d is adjusted by the side-of-head contact portion 3d being moved with respect to the sandwiching arm 3c to a position at which the side-of-head contact portion 3d can cover the ear of the user.

When the weight Ws of the weight 5 is fixed, the distances z2 and z2′ are calculated using Formulas (1) and (2), and the weight arm 4 is moved on the basis of the calculation. This results in enabling the center of gravity EG of the entirety the HMD 101 to be arranged near the neck.

In the present embodiment, the distance from the center of gravity HG to the center of gravity EG, the distance from the center of gravity EG to the center of gravity SG, and a weight balance between the HMD body 1 and the weight 5 have been simply described using the distances in the z direction. However, optimal weight and position of the weight 5 may be set in consideration of the elastic deformation of the HMD-body arm 2 and the weight arm 4, and the present technology is not limited to the relationships indicated by Formulas (1) and (2).

FIG. 8 is a set of a front view (a) and a side view (b) each schematically illustrating the HMD 101 not being worn by a user.

As described above, the HMD-body arm 2 and the weight arm 4 can be respectively moved along the first and second grooves 3g and 3h (the uneven portions 3e and 3f) of the HMD holding section 3.

When the HMD 101 is not in use (is not attached), the HMD-body arm 2 can be moved such that the first joint 1g of the HMD body 1 is moved up to a position (a first back-away position) at which the first joint 1g is in contact with, or is situated near the holding-section body 3a (the end 3j (refer to (b) of FIG. 3)). Likewise, the weight arm 4 can be moved such that the weight 5 is moved up to a position (a second back-away position) at which the weight 5 is in contact with, or is situated near the holding-section body 3a (the end 3k (refer to (b) of FIG. 3)). This makes it possible to reduce a storage space.

Since the weight 5 backs away up to the second back-away position described above, the weight 5 does not obstruct a user when the user takes off the HMD 101. Further, when the HMD 101 is worn by the user and then the user himself/herself extends the weight arm 4 from the holding-section body 3a such that the center of gravity EG of the HMD 101 is situated at a desired position, this makes it possible to adjust the position of the weight 5. As described above, the HMD 101 is worn by a user in a state in which weights of the HMD body 1 and the weight 5 are balanced with each other on the basis of the center of gravity EG of the HMD 101. This makes it possible to provide a property of being easily detachable and a wearing comfort to a user. In this case, the HMD body 1 may be in contact with, or out of contact with the face of the user. Likewise, the weight 5 may be in contact with, or out of contact with, or out of contact with the back of the head of the user.

As described above, according to the present embodiment, when the position of the center of gravity of the HMD 101 is adjusted by moving the HMD body 1 and the weight 5, this enables the HMD 101 to be stable upon being worn and to be comfortable to wear without providing an excessive feeling of pressure to a user, even if the HMD 101 is worn by users of which the sizes of the head are different from each other.

Further, the weight 5 can be moved along the shape of an arc from the top of the head of a user to a portion situated near the back of the head of the user. This makes it possible to set a movement range broader, and to provide a property of being easily detachable to the user. Furthermore, it is possible to prevent the weight 5 from colliding with something in the surroundings and to make the HMD 101 smaller in size when the HMD 101 is not in use.

(Modification of HMD-Body Arm and Weight Arm)

With respect to how the HMD-body arm 2 and the weight arm 4 are held with respect to the holding-section body 3a, the HMD-body arm 2 and the weight arm 4 are not limited to being held due to the above-described forces of biasing performed by the protrusions 2a and 4a.

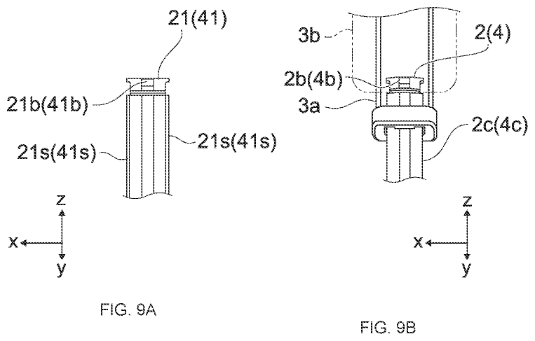

(a) of FIG. 9 is an enlarged plan view illustrating shapes of tips of an HMD-body arm 21 and a weight arm 41 according to a modification of the first embodiment of the present technology, and (b) of FIG. 9 illustrates how each of the HMD-body arm 21 and the weight arm 41 is attached to the holding-section body 3a.

On two side faces (two side faces that face each other in the x-axis direction), the HMD-body arm 21 includes a sliding portion 21s that has slidability. The sliding portion 21s is slidable along the first groove 3g of the holding-section body 3a, with specified friction being caused between the sliding portion 21s and the first groove 3g.

Likewise, on two side faces (two side faces that face each other in the x-axis direction), the weight arm 41 includes a sliding portion 41s that has slidability. The sliding portion 41s is slidable along the second groove 3h of the holding-section body 3a, with specified friction being caused between the sliding portion 41s and the second groove 3h.

The sliding portion 21s, 41s is made of, for example, a resin material such as an engineering plastics POM resin (POM) that has excellent durability and slidability. With respect to sliding resistances of the sliding portions 21s and 41s, the HMD body 1 is fixed to the HMD holding section 3 at an arbitrary position due to friction set depending on a dimensional relationship between the sliding portion 21s and the first groove 3g of the holding-section body 3a, and the weight 5 is fixed to the HMD holding section 3 at an arbitrary position due to friction set depending on a dimensional relationship between the sliding portion 41s and the second groove 3h of the holding-section body 3a. A force greater than the maximum static friction caused between the sliding portion and the groove is applied during movement. The magnitude of this friction is set such that the arms 21 and 41 are not moved with respect to the holding-section body 3a due to weights of the HMD body 1 and the weight 5.

According to the above-described biasing mechanism including the protrusions 2a and 4a and the uneven portions 3e and 3f, a resolution for an amount of a movement of each of the arms 2 and 4 with respect to the holding-section body 3a is restricted by a space between notch arcs of a corresponding one of the uneven portions 3e and 3f (that is, a distance corresponding to a pitch between adjacent notch arcs). On the other hand, according to this modification, the sliding portions 21s and 41s can be moved to any positions with respect to the holding-section body 3a. This makes it possible to finely adjust positions of the respective arms 21 and 41.

Note that a mechanism that is similar to the mechanism described above can also be adopted with respect to a positional adjustment between the tip of the sandwiching arm 3c and the side-of-head contact portion 3d, although this is not illustrated.

### Second Embodiment

FIG. 10 is a general schematic diagram illustrating an HMD according to a second embodiment of the present technology.

An HMD 102 according to the present embodiment has a configuration obtained by adding a weight drive section 7 described below to the configuration of the HMD 10 according to the above-described first embodiment of the present technology. Thus, in the present embodiment, a description of a configuration that is similar to the configuration in the first embodiment is omitted, and only the weight drive section 7 is described.

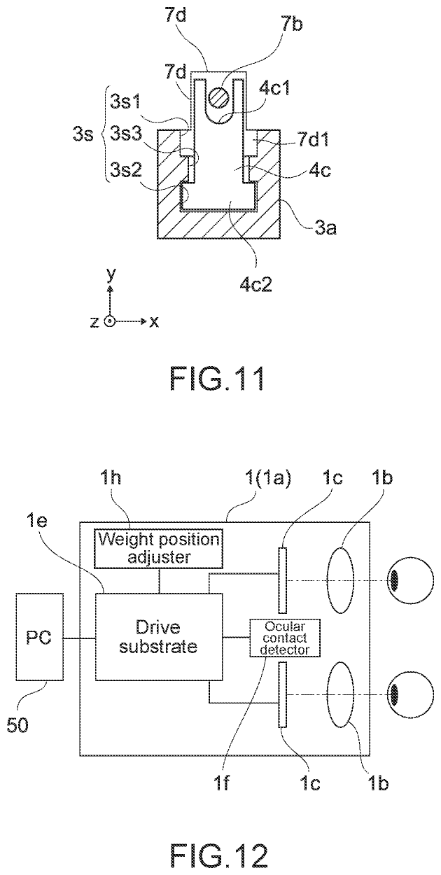

(a) of FIG. 10 is a side view illustrating the HMD 102 in which the weight arm 4 is in a back-away position. (b) of FIG. 10 is a side view illustrating the HMD 102 in which the weight arm 4 is in a maximal-extension position. FIG. 11 is a cross-sectional view along the line A-A of (a) of FIG. 10.

In the present embodiment, the HMD holding section 3 further includes the weight drive section 7. The weight drive section 7 includes an actuator 7a, a screw 7b, a spring 7c (a biasing member), and a movable block 7d.

The actuator 7a is typically an electric motor, and is integrally fixed to the holding-section body 3a. The screw 7b is arranged in the z-axis direction, and can be bidirectionally rotated about the z axis by the actuator 7a being driven.

The spring 7c is, for example, a tension coil spring, and is arranged around the weight arm 4. The spring 7c is provided between the holding-section body 3a and the weight 5, and biases the weight 5 in a direction of the holding-section body 3a (the second back-away position).

The movable block 7d includes a fitting portion 7d1 that includes a screw hole through which the screw 7b passes, and fits a guide groove 3s formed in an upper surface of the holding-section body 3a. The guide groove 3s extends in the z-axis direction, and includes an upper groove 3s and a lower groove 3s2 that face each other in the z-axis direction. A region between the upper groove 3s1 and the lower groove 3s2 is a space 3s3 that has a smaller width than the upper groove 3s1 and the lower groove 3s2 in the x-axis direction. By the actuator 7a being driven (by the screw shaft 7b being rotated), the fitting portion 7d1 of the movable block 7d fits the upper groove 3s1 along the upper groove 3s1 to be movable in the z-axis direction.

Further, the movable block 7d can be brought into contact with the protrusion 4c provided to the weight arm 4 at a specified position in the guide groove 3s1, and can press the protrusion 4c toward the rear side of a user along the z axis. The protrusion 4c is provided to protrude upward in the y-axis direction from the tip of the weight arm 4 inserted into the holding-section body 3a (the second guide groove 3h).

The protrusion 4c is situated further rearward than the movable block 7d. The protrusion 4c includes a notch 4c1 through which the screw 7b passes, and a fitting portion 4c2 that fits the lower groove 3s2 of the guide groove 3s. When the screw shaft 7b is rotated in a certain direction, the protrusion 4c can be moved rearward in the z-axis direction along the lower groove 3s2 under a pressing action caused by the movable block 7d. On the other hand, when the screw shaft 7b is rotated in a direction opposite to the certain direction, the protrusion 4c can be moved forward in the z-axis direction along the lower groove 3s2 under a biasing force generated by the spring 7c.

The weight drive section 7 having the configuration described above drives the actuator 7a (extends the drive shaft 7b), and presses the protrusion 4c rearward through the weight-arm movable portion 7d to adjust the position of the weight 5 (corresponding to the distance z2 in (b) of FIG. 6). The distance z2 can be set discretionarily according to the size of the head of a user, and the position of the weight 5 is adjusted using an adjustment amount that is preset when the HMD 102 is detected to be attached. The weight drive section 7 moves the weight arm 4 and the weight 5 at a specified speed between a back-away position illustrated in (a) of FIG. 10 (the second back-away position), and an adjustment position illustrated in (b) of FIG. 10 (the setting position).

Effects similar to the effects provided according to the first embodiment described above can be provided according to the present embodiment. In particular, the position of the weight 5 can be automatically adjusted to a specified position according to the present embodiment when the ocular contact detector 1f has detected that the HMD 102 is attached. This results in there being no need for a user to adjust the position of a weight, and thus in being able to further improve the wearability.

The HMD 102 further includes a weight position adjuster that drives the weight drive section 7. The weight position adjuster may be configured as a portion of the drive substrate 1e, or may be configured as an independent unit (refer to FIG. 12).

FIG. 12 is a control block diagram of the HMD 102. Here, the drive substrate 1e is connected by wire or wirelessly (using, for example, Bluetooth (registered trademark)) to an information processing apparatus 50 such as an external PC or a smartphone. The weight position adjuster 1h outputs a drive instruction to the actuator 7a on the basis of an instruction given by the drive substrate 1e.

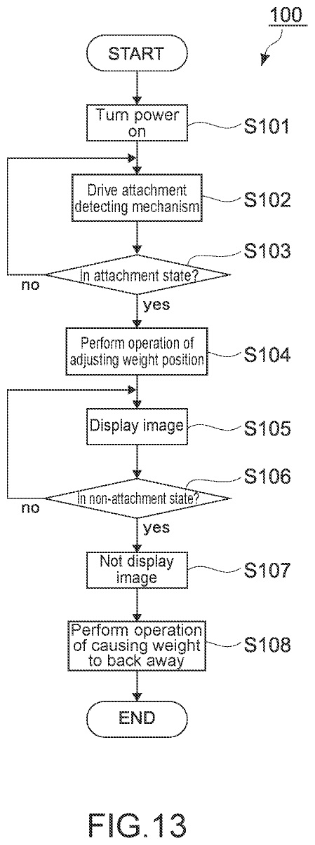

FIG. 13 is a flowchart illustrating an example of a weight position adjusting method 100 according to the present technology.

When the HMD 102 is turned on (Step 101), the drive substrate 1e drives the ocular contact detector 1f (Step 102), and determines whether the HMD 102 is attached (Step S103).

When the HMD 102 has been determined to be attached, the drive circuit 1e drives the actuator 7a through the weight position adjuster 1h, and moves the weight arm 4 to move the weight 5 from the back-away position ((a) of FIG. 10) to the setting position ((b) of FIG. 10). The setting position for the weight 5 may be a position determined in advance by a user according to the size of his/her head, as described above, or may be a predetermined position that is calculated from a weight of the entirety of the HMD 102 and an average size of a human body. Alternatively, an inertial sensor such as a gyroscope or an acceleration sensor may be included in the HMD 102, output of the inertial sensor may be referred to, and may determine whether a balance between the HMD body 1 and the weight 5 is achieved.

After the position of the weight 5 is adjusted to the setting position, the drive substrate 1e displays a specified image on the panel 1c, and presents a VR image or an MR image to the user (Step 105). The drive circuit 1e continuously detects whether the HMD 102 is attached, on the basis of output of the ocular contact detector 1f. When the HMD 102 is attached (when the HMD 102 is not in a non-attachment state) (“no” in Step 106), an image is continuously displayed (Step 105). When the HMD 102 is not attached (“yes” in Step 106), an image is not displayed (Step 107), and the weight drive section 7 is driven such that the weight 5 returns to the back-away position (Step 108).

### Third Embodiment

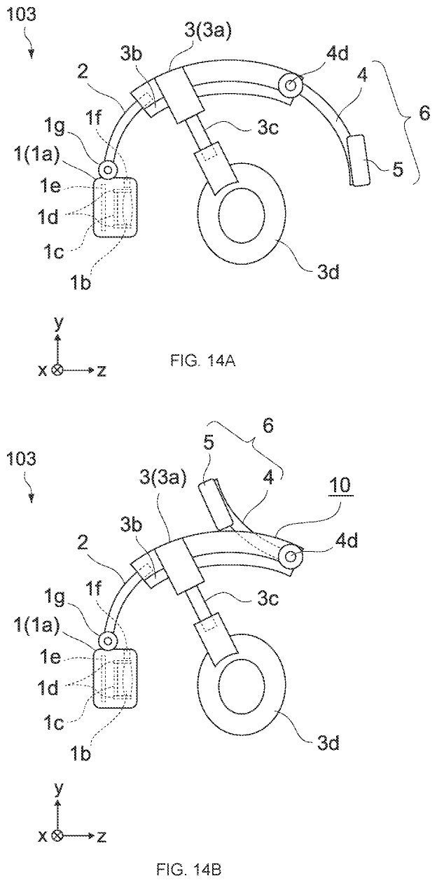

(a) and (b) of FIG. 14 are side views each schematically illustrating an HMD 103 according to a third embodiment of the present technology.

In the first embodiment described above, the weight section 6 can be moved back and forth with respect to the HMD holding section 3. The HMD holding section 3 of the HMD 103 according to the present embodiment includes a second joint 4d that makes it possible to rotate the weight section 6 with respect to the holding-section body 3a.

The second joint 4d is provided between the holding-section body 3a and the weight arm 4, and makes it possible to rotate the weight section 6 about the x axis. Consequently, the weight section 6 can be rotated between a setting position illustrated in (a) of FIG. 14 and a back-away position illustrated in (b) of FIG. 14. The back-away position for the weight section 6 is not particularly limited, and is set directly on the HMD holding section 3 in the present embodiment.

In the HMD 103 according to the present embodiment, the weight section 6 can be moved along the shape of an arc from the top of the head of a user to the back of the head of the user. This also makes it possible to provide a property of being easily detachable to the user, as in the first embodiment. Further, it is possible to make the entirety of the HMD 10 smaller in size when the HMD 10 is not in use (is not attached).

Note that, with respect to the setting position for the weight section 6, the length and the shape of the weight arm 4 are set such that the weight 5 is arranged at a position at which the weight of the weight 5 is balanced with the weight of the HMD body 1.

Further, the weight section 6 may be rotated by a manual operation being performed by a user, or a drive section that can automatically switch the position of the weight section 6 may be included, as in the second embodiment.

Note that the present technology may also take the following configurations.

(1) A head-mounted image display apparatus, including:

a display-section body that displays an image in front of eyes of a user;

a holding section that is mounted on a head of the user, and includes a first arm that movably holds the display-section body; and

a weight section that includes a weight, and a second arm that is provided to the holding section and movably holds the weight, the weight section being balanced with the display-section body in the holding section.

(2) The head-mounted image display apparatus according (1), in which

the holding section includes a holding-section body that includes a first groove and a second groove that are respectively used to accommodate the first arm and the second arm, and

the first arm and the second arm are respectively movable within and along the first groove and the second groove.

(3) The head-mounted image display apparatus according to (2), in which

the first arm and the second arm form an arc shape, and the first groove and the second groove form an arc shape.

(4) The head-mounted image display apparatus according to any one of (1) to (3), in which

the display-section body includes a barrel that holds an optical element and a display element, and

the barrel is movable in the display-section body in a direction of a line of sight of the user.

(5) The head-mounted image display apparatus according to (4), in which

the holding section further includes a first joint that enables the display-section body to be rotated about a single axis with respect to the first arm.

(6) The head-mounted image display apparatus according to (2), in which

the first arm is movable such that the display-section body is moved up to a first back-away position at which the display-section body is in contact with, or is situated near the holding-section body.

(7) The head-mounted image display apparatus according to any one of (1) to (6), in which

the holding section further includes sandwiching arms between which the head of the user is sandwiched from two sides of the head.

(8) The head-mounted image display apparatus according to (7), in which

the holding section further includes a side-of-head contact portion that is provided to a tip of the sandwiching arm and covers a corresponding one of two ears of the user.

(9) The head-mounted image display apparatus according to (2), in which

the second arm is movable such that the weight is moved up to a second back-away position at which the weight is in contact with, or is situated near the holding-section body.

(10) The head-mounted image display apparatus according to (2), in which

each of the first groove and the second groove includes an uneven portion on two side faces of the corresponding groove, and

each of the first arm and the second arm includes a tip that includes an elastically deformable protrusion that is engaged with the corresponding uneven portion.

(11) The head-mounted image display apparatus according to (2), in which

the first arm includes a sliding portion that is slidable along the first groove, with specified friction being caused between the sliding portion of the first arm and the first groove, and

the second arm includes a sliding portion that is slidable along the second groove, with specified friction being caused between the sliding portion of the second arm and the second groove.

(12) The head-mounted image display apparatus according to (9), in which

the holding section further includes a weight drive section that moves the weight from the second back-away position to a specified position.

(13) The head-mounted image display apparatus according to (12), in which

the weight drive section includes
an actuator that moves the weight from the second back-away position to the specified position, and
a biasing member that biases the weight toward the second back-away position from the specified position.
   (14) The head-mounted image display apparatus according to any one of (1) to (13), in which

the holding section further includes a second joint that enables the weight section to be rotated about a single axis.

### REFERENCE SIGNS LIST

1 HMD body
2 HMD-body arm (first arm)
3 HMD holding section (holding section)
3a holding-section body
4 weight arm (second arm)
5 weight
6 weight section
7 weight drive section
101, 102, 103 head-mounted image display apparatus (HMD)

1. A head-mounted image display apparatus, comprising:
a display-section body that displays an image in front of eyes of a user;
a holding section that is mounted on a head of the user, and includes a first arm that movably holds the display-section body; and
a weight section that includes a weight, and a second arm that is provided to the holding section and movably holds the weight, the weight section being balanced with the display-section body in the holding section.

2. The head-mounted image display apparatus according to claim 1, wherein
the holding section includes a holding-section body that includes a first groove and a second groove that are respectively used to accommodate the first arm and the second arm, and
the first arm and the second arm are respectively movable within and along the first groove and the second groove.

3. The head-mounted image display apparatus according to claim 2, wherein
the first arm and the second arm form an arc shape, and the first groove and the second groove form an arc shape.

4. The head-mounted image display apparatus according to claim 1, wherein
the display-section body includes a barrel that holds an optical element and a display element, and
the barrel is movable in the display-section body in a direction of a line of sight of the user.

5. The head-mounted image display apparatus according to claim 4, wherein
the holding section further includes a first joint that enables the display-section body to be rotated about a single axis with respect to the first arm.

6. The head-mounted image display apparatus according to claim 2, wherein
the first arm is movable such that the display-section body is moved up to a first back-away position at which the display-section body is in contact with, or is situated near the holding-section body.

7. The head-mounted image display apparatus according to claim 1, wherein
the holding section further includes sandwiching arms between which the head of the user is sandwiched from two sides of the head.

8. The head-mounted image display apparatus according to claim 7, wherein
the holding section further includes a side-of-head contact portion that is provided to a tip of the sandwiching arm and covers a corresponding one of two ears of the user.

9. The head-mounted image display apparatus according to claim 2, wherein
the second arm is movable such that the weight is moved up to a second back-away position at which the weight is in contact with, or is situated near the holding-section body.

10. The head-mounted image display apparatus according to claim 2, wherein
each of the first groove and the second groove includes an uneven portion on two side faces of the corresponding groove, and
each of the first arm and the second arm includes a tip that includes an elastically deformable protrusion that is engaged with the corresponding uneven portion.

11. The head-mounted image display apparatus according to claim 2, wherein
the first arm includes a sliding portion that is slidable along the first groove, with specified friction being caused between the sliding portion of the first arm and the first groove, and
the second arm includes a sliding portion that is slidable along the second groove, with specified friction being caused between the sliding portion of the second arm and the second groove.

12. The head-mounted image display apparatus according to claim 9, wherein
the holding section further includes a weight drive section that moves the weight from the second back-away position to a specified position.

13. The head-mounted image display apparatus according to claim 12, wherein
the weight drive section includes
an actuator that moves the weight from the second back-away position to the specified position, and
a biasing member that biases the weight toward the second back-away position from the specified position.

14. The head-mounted image display apparatus according to claim 1, wherein
the holding section further includes a second joint that enables the weight section to be rotated about a single axis.
